(19) United States
(12) Patent Application Publication
(10) Pub. No.: US 2008/0128929 A1
(43) Pub. Date: Jun. 5, 2008

(54) Method for Manufacturing Optical Devices

(75) Inventors: Marco Colombo, Milano (IT); Johann Osmond, Milano (IT); Antonio Zaopo, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PIRELLI & C. S. p.A, Milan (IT)

(21) Appl. No.: 11/792,295

(22) PCT Filed: Dec. 23, 2004
(86) PCT No.: PCT/EP04/14740

§ 371 Date: Jun. 14, 2007

(51) Int. Cl. G02B 6/028

(52) U.S. Cl. 264/1.24

(57) ABSTRACT

A method for manufacturing an optical device including at least one silicone elastomer optical waveguide includes the steps of providing a substantially rigid mold with a patterned surface, providing a core layer of a curable silicone elastomer, patterning the core layer by means of the patterned surface of the substantially rigid mold, curing the patterned core layer, and removing the substantially rigid mold from the patterned core layer. The method advantageously allows the manufacture of an optical device including at least one optical waveguide in a single step and in a reproducible manner.

### FIELD OF THE INVENTION

The present invention relates to a method for manufacturing optical devices. Specifically, the invention relates to a method for manufacturing optical devices comprising silicone elastomer optical waveguides of improved quality in terms of dimensional and shape precision, as well as in terms of low optical loss.

### PRIOR ART

In optical communication systems, messages are transmitted by carrier waves at optical frequencies which are generated by sources such as lasers and light-emitting diodes. There is interest in such optical communication systems because they offer several advantages over conventional communication systems.

One means for switching or guiding waves of optical frequencies from one point to another is by an optical waveguide. The operation of an optical waveguide, in particular, is based on the fact that when a light-transmissive medium (known in the art as “core”) is surrounded or otherwise bounded by at least another medium having a lower refractive index (known in the art as “cladding”), the light introduced along the core axis is reflected at the boundary with the surrounding medium, thus producing a guiding effect.

A wide variety of optical devices can be made which incorporate a light guiding structure as the light transmissive elements. Such devices comprise, for example, components such as channel optical waveguides, ridge, raised strip, embedded strip, diffused, rib and inverted rib waveguides, optical couplers, optical splitters, optical switches, optical filters, variable attenuators, micro-optical elements and the like, as from U.S. Pat. No. 6,555,288, for example.

Typically, an optical waveguide comprises:
a support,
a lower cladding layer formed on the support (the lower cladding layer being optional, depending on the value of the refractive index of the support),
a core layer formed on the lower cladding layer (if present) or on the support (if this has a refractive index lower than the refractive index of the core), the core layer being provided with a rib portion integral with the core layer, and
an upper cladding layer formed on the core layer.

Optical waveguides and other optical devices comprising a core and/or cladding layer(s) made of elastomeric materials, such as silicones, are known. The waveguides made of elastomeric materials are heat and moisture resistance, have low loss at 1550 nm wavelength, which is the wavelength commonly used in telecommunication applications, have low birefringence and high thermo-optic coefficient (dn/dT).

As is well known in this art, birefringence is the difference between the refractive index of the transverse electric or TE polarization (parallel to the support surface) and the transverse magnetic or TM polarization (perpendicular to the support surface). Such birefringence is undesirable in that it can cause optical devices to show substantial polarization dependant losses and increased bit error rates in telecommunication systems.

A first known method for manufacturing an elastomeric optical waveguide is based on the so-called photolithography process, which is carried out over a layer of elastomeric material, as reported, for example, by U.S. Pat. No. 6,084,050 and U.S. Pat. No. 5,972,516. Both such documents refer to optical waveguides made of materials comprising siloxane bonds (—Si—O—Si—) in the main chain.

Photolithography is a traditional process involving selective exposure through an appropriate mask of a light-sensitive polymeric layer deposited on the core layer, in order to develop a pattern. Development may be accomplished, for example, by removal of the unexposed portion of the photopolymeric layer by an appropriate solvent and then by different steps of reactive ion etching (R.I.E.) on the core layer.

A method based on such a process is however quite long and expensive, in that it involves a series of complex steps, namely those of masking and of reactive ion etching the layer made of elastomeric material. Furthermore, the reactive ion etching (R.I.E.) of an elastomeric material such as a material comprising a siloxane bond can bring drawbacks: the gas employed in the etching process can either form a passivating layer (e.g. SiO₂, as can be observed if oxygen is used) or can show to be not sufficiently selective in the sense that the etching is not limited to the elastomeric layer, but may affect also a possible underlying layer (as can be observed if a blend of fluorinated and chlorinated gases is used).

Furthermore, the Applicant observed that the siloxane optical devices obtained by manufacturing methods including a R.I.E. step can have surface defects which lead to propagation loss.

The Applicant perceived that the optical losses in optical devices made of siloxane materials can be due to the fact that R.I.E. can yield roughness of the core surface, and this may result in unacceptable scattering losses.

EP-A-1 118 884 discloses another method for manufacturing an optical waveguide, namely by molding an organopolysiloxane material obtained by means of a sol-gel process. More particularly, EP-A-1 118 884 discloses a method for manufacturing optical waveguides made of polyorganosiloxanes formed by selecting raw materials for a sol-gel material which provide a dimethylsiloxane and a phenylsiloxane through hydrolytic and dehydration/condensation reactions. In order to manufacture an optical element covered with a film having a surface which is the inversion of the surface of a mold, EP-A-1 118 884 provides a process comprising the steps of pouring a sol-gel material over the surface of the substrate, a first heating to carry out a dehydration/polycondensation, pressing the mold against the film on the surface of an article when the liquid film achieves plasticity, a second heating in this state to almost complete the dehydration/polycondensation reaction of the sol-gel material for gelation, transfer molding, releasing the mold, and a third and final heating of the film to completely polycondense the film and vaporize water formed by this polycondensation.

Firstly, as a consequence of the application of such a process, in order to promote the dehydration/polycondensation reaction, three distinct heating steps are carried out, which result in a shrinkage of the elastomeric film and in an ensuing cracking of the elastomeric film.

Secondly, residual hydroxyl groups can be present in the resulting material, which yields an unacceptable loss at a wavelength of 1550 nm.

Thirdly, the elastomeric film so obtained has an uncontrolled porosity, which can provide an unpredictable refractive index and scattering losses.

### SUMMARY OF THE INVENTION

The Applicant observed that although silicone elastomer materials are heat and moisture resistant, have low loss at 1550 nm wavelength, have low birefringence and high thermo-optic coefficient, the manufacturing methods of the prior art intended to manufacture optical devices made of such elastomeric materials are unsatisfactory in that, on the one side, they comprise a number of steps making such known methods too complex and time-consuming, and in that, on the other side, the optical devices manufactured by such methods can show unacceptable optical loss due to a poor dimensional precision.

In particular, the Applicant has observed that the complexity of the manufacturing methods of the prior art show drawbacks that can hold back from using silicone elastomers despite the advantageous properties of such materials.

Accordingly, the Applicant perceived the need of devising a new method for manufacturing silicone elastomer optical devices, for example silicone optical waveguides, provided with a predetermined pattern, in particular but not exclusively of the rib and inverted rib type, which allows to manufacture such devices with a reduced number of steps, while ensuring to obtain a dimensional precision such to maintain or enhance the optical properties, especially in terms of reduced optical losses, which are intrinsic of silicone elastomer materials.

In this regard, the Applicant observed that in order to obtain silicone elastomer optical devices in a reduced number of steps, the very properties of silicone elastomer materials, and particularly the elasticity and the low adhesion to other materials, may be conveniently exploited.

The Applicant observed that a silicone elastomer optical device can be obtained by molding a layer of a curable silicone elastomer with a patterned substantially rigid mold. By molding a layer of a curable elastomeric material with a substantially rigid mold having a predetermined patterned surface, it is advantageously possible to provide the elastomeric layer with a corresponding resulting pattern which is the negative of the pattern of the mold, such resulting pattern having a neat shape. Furthermore, a substantially rigid mold, preferably but not exclusively made of a polymer, can be advantageously used more than once without loss of the desired reproducibility and without any damage because silicone elastomers show a low adhesion to a very broad range of materials adapted to form a mold.

The present invention, therefore, relates to a method for manufacturing an optical device comprising at least one silicone elastomer optical waveguide, said method comprising the steps of:
providing a substantially rigid mold with a patterned surface;
providing a core layer made of a curable silicone elastomer;
patterning said core layer by means of the patterned surface of the substantially rigid mold;
curing the patterned core layer; and
removing said substantially rigid mold from said patterned core layer.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

Thanks to the fact that the core layer is made of a curable silicone elastomer, and that the patterning step is effected by a patterned surface of a substantially rigid mold, it is advantageously possible to obtain an elastomeric device in a single step.

In particular, differently from the prior art manufacturing method based on a sol-gel process, which requires a number of heating steps to carry out the dehydration/polycondensation, the method of the present invention can comprise a single heating step or none at all. In particular, a single heating step is provided in case the curing step is a thermal curing, while no heating step is necessary if the curing step is a photocuring, for example a UV curing step.

Furthermore, thanks to the fact that silicone elastomers show a low adhesion to a very broad range of materials adapted to form a mold, such as, as described in more detail in the following, polymers, fluorinated polymers, but also inorganic materials, the material intended to form the mold may be selected within a broad range of materials.

Because of such low adhesion of silicone elastomers, the mold can be advantageously used more than once, while achieving the desired reproducibility of the predetermined pattern, thus ensuring a dimensional and shape precision of the pattern reproduced on the core layer, as well as an improved surface smoothness.

Furthermore, since to cure the materials used in this invention dehydration/condensation reactions like in sol-gel process are not required, substantially no hydroxyl groups are present in the core layer, with advantageous attainment of improved transmission capability at a wavelength of 1550 nm of the optical device manufactured according to the invention.

According to a preferred embodiment of the method of the invention, the core layer has an initial volume and the cured patterned core layer has a final volume which is substantially equal to said initial volume.

In the present description and in the claims, the final volume is intended to be substantially equal to the initial volume if no volume shrinkage of the cured core layer is observed with respect to the volume of the core layer measurable before the curing step or, at the maximum, a volume shrinkage of 5%.

Preferably, the above-mentioned final volume of the core layer after the curing step is 95-100% of the initial volume of the core layer before the curing step.

Preferably, the core layer is made of a thermally curable silicone elastomer.

An example of curable silicone material is polydimethylsyloxane (PDMS). A preferred alternative of curable silicone elastomer is a polyphenylmethylsyloxane (PPMS). If the curable silicone elastomer is a PPMS, the ratio of methyl and phenyl groups can be advantageously used to control and modulate optical properties of the material, like refractive index and optical loss.

Alternatively, the core layer is made of a UV curable silicone elastomer. For example, it can contain photocurable functional groups like acrylates. In such preferred embodiment, the mold is preferably made of a substantially rigid material transparent to UV light, so that the curing step of the patterned core layer may precede the removing step of the method of the invention.

According to a preferred embodiment of the method of the invention, the patterned surface of the mold, for example intended to form the ribs of an elastomeric optical waveguide, shows recesses in the mold. Advantageously, in such manner a rib optical waveguide may be produced.

Alternatively, the patterned surface of the mold shows projections protruding from the mold. Advantageously, in such manner an inverted rib optical waveguide may be produced.

Although the present description is mainly focused upon the manufacture of rib waveguides, the method according to the present invention may be carried out to manufacture any optical device. In particular, the method may be carried Out to manufacture, for example, optical components such as rib and inverted rib waveguides, optical couplers, optical splitters, optical switches, optical filters, variable attenuators, micro-optical elements and the like.

Preferably, the mold is made of a polymeric material.

Polymeric materials can also be easily processed and show excellent mechanical properties.

Preferably, the polymeric material is curable and, more preferably, photocurable, for example UV curable.

Alternatively, the mold can be made of a thermoplastic polymeric material.

A curable polymeric mold may be advantageously manufactured by conventional techniques, e.g. by pouring a polymeric material in liquid form on a master provided with recesses and/or protrusions corresponding to the ribs of the optical device to be produced. A sheet is preferably leant on the uncured polymeric material in order to obtain a solid support for the mold, which can be made of an inorganic material, such as glass. Finally the polymeric material is cured.

Alternatively, a polymeric mold may be advantageously manufactured by injection molding, by a conventional photolithographic process or by an imprinting technique, such as hot embossing or UV imprinting lithography.

According to a preferred embodiment of the method of the invention, the mold is made of a fluorinated polymeric material.

By suitably selecting the substantially rigid material constituting the mold within such preferred class of materials, an improved releasability of the mold from the core layer may be advantageously achieved. As a result, a further advantage is achieved, namely that the mold may be re-used a high number of times, which allows to manufacture an optical device at minimized manufacturing costs.

Preferably, the fluorinated polymeric material of which the mold is made is selected from fluorinated acrylate and methacrylate polymers, fluorinated polyacetates, fluorinated polyesters, fluorinated polystyrene, PVDF, fluorinated polycarbonates, fluorinated polyimides, fluorinated polyethyleneterephtalates (PET), fluorinated polycyclobutanes, fluorinated polycyanates, or combination thereof.

The fluorinated acrylate and methacrylate polymers are preferably selected from fluorinated polymethylmethacrylate, fluorinated polybutylacrylate, fluorinated polyethylexylacrylate, fluorinated polyisodecylacrylate, fluorinated polyhydroxyethylacrylate, fluorinated polyhydroxypropylacrylate, fluorinated poycycloexylacrylate, fluorinated polybutane-dioldiacrylate, fluorinated polydiacrylate, fluorinated polyneopentylglycoldiacrylate, fluorinated polydiethyleneglycoldiacrylate, fluorinated polydiethyleneglycoldimethacrylate, fluorinated polyexyanedioldiacrylate.

According to an alternative embodiment of the method of the invention, the mold is made of an inorganic material which can be advantageously manufactured by a conventional technique, e.g. by a photolithographic process or by an imprinting technique.

The mold is preferably made of an inorganic material selected from: Si, Cr, Ni, Pt, Ti.

A silicon mold may be advantageously patterned by a conventional photolithographic technique comprising resist deposition, UV irradiation through a mask, Reactive Ion Etching.

A metal mold, for example made of one of the preferred metals indicated above, may be advantageously manufactured by a conventional technique such as electroplating or sputtering.

When the mold is made of an inorganic material such as one of the preferred inorganic materials described above, the preferred embodiment of the method of the invention further comprises the step of applying a releasing agent on the patterned surface of the mold before the above-mentioned step of patterning the core layer.

In this way, an enhanced releasability of the mold from the core layer may be advantageously achieved.

As an illustrative example, the releasing agent may be hexamethyldisilazane (HMDS). Alternatively, the releasing agent may be a fluorine based releasing agent (e.g. Daifree® compounds by Daikin Industries Ltd.)

The core layer can be provided either in direct contact with a support or arranged on a support previously provided with a lower cladding layer of a predetermined material having a refractive index lower than the refractive index of the core layer. In the latter case, the above-mentioned predetermined material is thus in contact with the elastomeric material of the core layer.

If present, the lower cladding layer is preferably of a first elastomeric material, which is thus in contact with the elastomeric material of the core layer.

The core layer and the optional lower cladding layer can be provided on the support in liquid form by different methods known in the art, such as spin coating, dip coating, slot coating, roller coating, doctor blading, liquid casting or the like.

The support can be made of any material suitable to perform a support action for the elastomeric material to be patterned by means of the substantially rigid mold.

Advantageously, the support is made of a material provided with heat resistance, mechanical strength, elastic modulus and chemical resistance. Examples of material suitable for the support are polyetherimide, polyimide, polycarbonate, polyurethane, quartz and glass.

In order to improve the adhesion of the core layer and of the optional lower cladding layer to the support, the latter may be preliminary cleaned and treated with an adhesion promoter. The support may contain other devices, either topographical features such as grooves or electrical circuits, or electro-optical devices such as laser diodes.

When the core layer is provided in direct contact with the support, the latter is made of a material with a refractive index lower than that of the silicone elastomer of the core layer.

When the support is provided with a lower cladding layer, the refractive index of the Support material becomes irrelevant to the operation of the optical device.

The first elastomeric material has a refractive index lower than that of the elastomeric material. Preferably, said first elastomeric material is a material selected, for example, from the group mentioned above in connection with the elastomeric material of the core layer.

The first elastomeric material is preferably a curable silicone material having a lower refractive index than the refractive index of the core layer.

Preferably, the first elastomeric material is a polysyloxane having a lower refractive index than the refractive index of the core layer.

Preferably, the first elastomeric material is a polyphenylmethylsyloxane (PPMS) having a lower refractive index than the refractive index of the core layer.

Another illustrative example of elastomeric material adapted to form a lower cladding layer is polydimethylsyloxane (PDMS).

When the first elastomeric material is a curable material provided on the support in liquid form, a curing treatment thereof is preferably effected before providing the core layer thereupon. For example, the first elastomeric material can be cured by thermal treatment or by actinic radiation, for example UV radiation.

Alternatively, the first elastomeric material is cured after being provided on the support.

Advantageously, the UV curing is effected substantially in the absence of oxygen, for example under a nitrogen flow.

The thermal curing conditions can be determined by the skilled in the art on the basis of the product sheet of the first elastomeric material (e.g. for a period of time of 1 h at a temperature of 100° C., for a period of time of 4 h at a temperature of 65° C.).

The curing step of the patterned core layer may precede or follow the removing step of the method of the invention.

The curing of the core layer is preferably effected by thermal treatment or, alternatively, by actinic radiation, for example UV radiation. Preferably, such UV curing is effected substantially in the absence of oxygen, for example under a nitrogen flow.

The thermal curing is for example effected at a temperature of 150° C. for a period of time of 2 h, or for a longer time at a lower temperature.

Preferably, the method of the present invention further comprises the step of providing an upper cladding layer of a second material, preferably a second elastomeric material, on the core layer, after the step of removing the substantially rigid mold from the patterned core layer.

Said upper cladding layer is preferably provided on the core layer after curing the latter.

Said upper cladding layer can be provided using a known technique, for example one of those listed in connection with the deposition of the core layer and of the optional lower cladding layer on the support.

The second elastomeric material is preferably a curable silicone material, preferably having a lower refractive index than the refractive index of the core layer.

Preferably, when the second elastomeric material is a curable material provided in liquid form, a curing treatment thereof is effected. For example, the second elastomeric material can be cured by thermal treatment or, preferably, by actinic radiation, for example UV radiation. Preferably, such UV curing is effected substantially in the absence of oxygen, for example under a nitrogen flow, and preferably at room temperature.

Preferably, the second elastomeric material is cured after being provided oil the core layer.

Preferably, the second elastomeric material is a polysyloxane having a lower refractive index than the refractive index of the core layer.

Preferably, said second elastomeric material is an elastomeric material selected from the group mentioned above in connection with the elastomeric material of the core layer.

Preferably, said first elastomeric material and said second elastomeric material both belong to a same class of materials. More preferably, said elastomeric material of the core layer, as well as said first and second elastomeric material all belong to the same class of materials.

Preferably, said first elastomeric material and said second elastomeric material have substantially equal refractive indexes.

Preferably, said first elastomeric material and said second elastomeric material are equal.

A further elastomeric material may be applied upon the upper cladding layer. Such further elastomeric material can be added, for example, when the optical device comprises a plurality of optical waveguides provided in multilayer arrangement.

The method according to the present invention advantageously allows to manufacture an optical device including at least one optical waveguide in a single step and in a reproducible manner.

The compatibility between the substantially rigid mold and the silicon elastomer to be patterned enables to obtain a patterned core layer with an improved surface smoothness with respect to that of the optical devices obtainable by the prior art methods based on the photolithography technique, with a consequent reduction of the optical loss, particularly of the scattering loss.

The method of the invention advantageously allows to produce a silicone elastomer optical device having high dimensional and shape precision, which advantage is particularly important in the manufacture of rib and inverted rib waveguides, where a precise reproduction of the profile of the ribs is required in order to minimize the optical loss of the optical device.

In addition to the improvement of the quality of the optical device, the method of the invention also enjoys from the advantages deriving from the use of a substantially rigid mold, with advantageous reduction in the number of steps and simplification thereof with respect to the etching technique of the prior art.

Furthermore, as described in more detail in the following, the method of the invention advantageously allows to obtain an optical device of the type including a number of superimposed layers, namely a support, an optional lower cladding, a core, and an upper cladding layer, which structure is particularly suitable in forming light guiding structures.

### BRIEF DESCRIPTION OF THE DRAWINGS

Additional features and advantages of the invention will become more readily apparent from the description of some preferred embodiments of a method according to the invention for manufacturing an optical device, made hereafter with reference to the attached drawings in which, for illustrative and not limiting purposes, an optical device at different manufacturing steps of a preferred embodiment of the method of the invention is represented.

In the drawings:

FIGS. 1-5 are cross-longitudinal views of an optical device being manufactured at subsequent steps of an embodiment of the method of the invention.

### DETAILED DESCRIPTION OF THE PREFERRED EMBODIMENTS

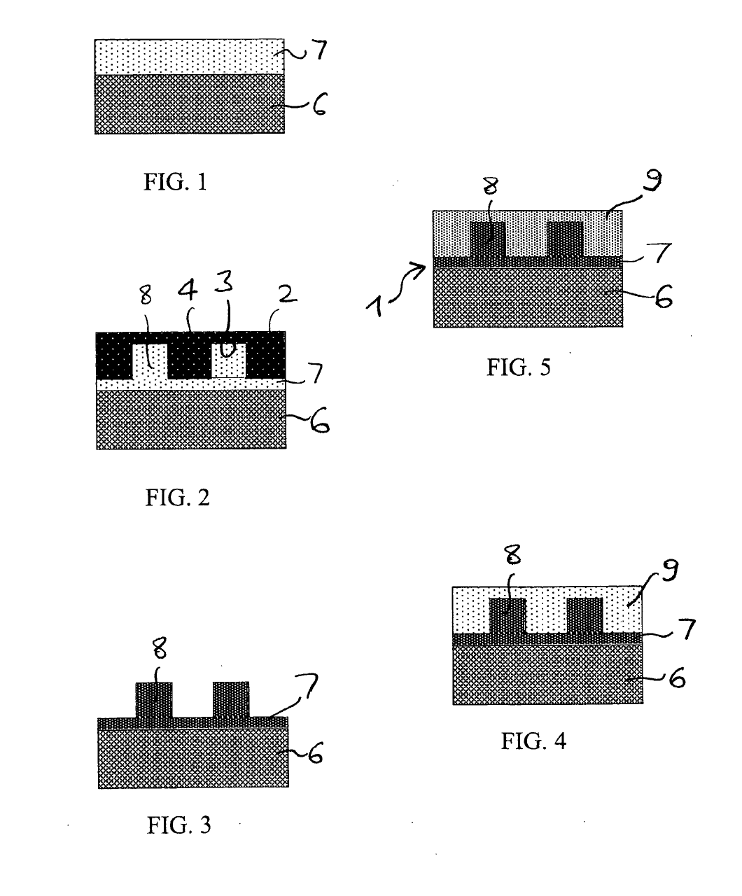

With reference to FIGS. 1-5, a sequence of manufacturing steps of an embodiment of the method of the invention for manufacturing an elastomeric optical device is schematically shown. In FIG. 5, showing the final step of such preferred embodiment, a finished optical device, which will be described in greater detail in the following, is generally indicated at 1. By way of illustrative example, in such figure an organic rib optical waveguide is schematically shown.

In a first step of the method of the invention, a substantially rigid mold 2 having a predetermined pattern is provided. The mold 2 is shown in use in FIG. 2.

The substantially rigid mold 2, made for example of UV curable fluorinated acrylate (ZPU 13-430, manufactured by Zen Photonics Co. Ltd., Moonji-Dong, Yusong-Gu, Daejeon, South Korea), is provided with a predetermined recessed pattern intended to form the ribs of the rib organic optical waveguide.

The substantially rigid mold 2 is provided with recesses 3—corresponding to the ribs of the optical device 1—alternatively arranged between projections 4, which are integrally formed with the substantially rigid mold 2 by way of a conventional technique as described in detail in the following.

The substantially rigid mold 2 is formed by pouring the above-mentioned UV curable fluorinated acrylate in liquid form, on a master device (not shown as conventional per se), made for example of silicon, provided with a pattern comprising projections corresponding to the recesses 3 of the mold 2, which pattern is obtained for example by a standard photolithography technique. An inorganic support sheet, for example made of quartz, not shown, is held horizontally by a conventional positioning device and leant by the same on the liquid. The mold is then UV cured by means of a Fusion D lamp (about 3 J/cm²) at room temperature. The substantially rigid mold 2 is finally removed by peeling off from the silicon master device and is ready to be used as mold for forming the optical device 1.

According to an optional step of the present method, a support of polyetherimide (Ultem®, manufactured by Goodfellow Cambridge, Ermine Business Park, Huntingdon, England) shaped as a sheet, not shown in the figures, may be provided.

According to a further optional step of the present method, a lower cladding layer 6 made, for example, of a thermally curable silicone elastomer such as polydimethylsiloxane (PDMS) (for example Sylgard 184, refractive index=1.410, manufactured by Dow-Corning, Midland USA), is provided in liquid form on the support, e.g. by spin-coating.

The lower cladding layer 6 is thermally cured at 150° C. for 15 min.

Subsequently, a core layer 7 of a thermally curable silicone elastomer, for example a polyphenylmethylsiloxane (for example OE 4100®, refractive index=1.460, manufactured by Dow-Corning, Midland, USA), of higher refractive index with respect to the refractive index of the lower cladding layer 6 is provided in liquid form on the lower cladding layer 6 (FIG. 1), e.g. by spin coating.

Subsequently, the core layer 7 is patterned by means of the substantially rigid mold 2 (FIG. 2), which can be guided against the core layer 7 by a conventional positioning device. In such manner, the core layer 7 is provided with a number of ribs 8 corresponding to the recesses 3 of the elastomeric mold 2. As schematically shown in FIG. 3, the core layer 7 is then thermally cured at 150° C. for 120 min.

The substantially rigid mold 2 is then removed by peeling off from the patterned core layer 7 and may be re-used a number of times to pattern a further core layer of a new optical device being formed.

Subsequently, according to a preferred embodiment of the present method, an upper cladding layer 9 of a thermally curable silicone elastomer, such as for example polydimethylsiloxane (PDMS) (for example Sylgard 184, refractive index=1.410, manufactured by Dow-Corning, Midland, USA) of lower refractive index with respect to the refractive index of the core layer 7, is provided in liquid form on the patterned core layer 7 (FIG. 4), e.g. by spin coating.

The upper cladding layer 9 is then thermally cured at 150° C. for 15 min (FIG. 5).

In such manner, the finished optical device 1 including an elastomeric rib optical waveguide comprising a core surrounded by a cladding having a lower refractive index, is manufactured (FIG. 5).

Alternatively, according to the method of the invention an optical device including a silicone elastomer inverted rib optical waveguide comprising a core surrounded by a cladding having a lower refractive index, may be manufactured. In order to manufacture such a device of the inverted rib type, it is sufficient to pattern the lower cladding layer, forming a groove of the core layer dimensions. The groove is filled with the core layer, defining also the outer rib height.

1-26. (canceled)

27. A method for manufacturing an optical device comprising at least one silicone elastomer optical waveguide, comprising the steps of:
providing a substantially rigid mold with a patterned surface;
providing a core layer made of a curable silicone elastomer;
patterning said core layer by means of the patterned surface of the substantially rigid mold;
curing the patterned core layer; and
removing said substantially rigid mold from said patterned core layer.

28. The method according to claim 27, wherein the core layer has an initial volume and the cured patterned core layer has a final volume which is substantially equal to said initial volume.

29. The method according to claim 28, wherein the final volume is 95-100% of the initial volume.

30. The method according to claim 27, wherein the core layer is made of a thermally curable silicone elastomer.

31. The method according to claim 30, wherein the core layer is made of a material selected from polyphenylmethylsiloxanes and polydimethylsiloxane.

32. The method according to claim 27, wherein the mold is made of a polymeric material.

33. The method according to claim 32, wherein the mold is made of a fluorinated polymeric material.

34. The method according to claim 33, wherein the fluorinated polymeric material is selected from fluorinated acrylate and methacrylate polymers, fluorinated polyacetates, fluorinated polyesters, fluorinated polystyrene, PVDF, fluorinated polycarbonates, fluorinated polyimides, fluorinated polyethyleneterephtalates, fluorinated polycyclobutanes, fluorinated polycyanates, or combinations thereof.

35. The method according to claim 34, wherein the fluorinated acrylate and methacrylate polymers are selected from fluorinated polymethylmethacrylate, fluorinated polybutylacrylate, fluorinated polyethylexylacrylate, fluorinated polyisodecylacrylate, fluorinated polyhydroxyethylacrylate, fluorinated polyhydroxypropylacrylate, fluorinated poycycloexylacrylate, fluorinated polybutane-dioldiacrylate, fluorinated polydiacrylate, fluorinated polyneopentylglycoldiacrylate, fluorinated polydiethylenegylcoldiacrylate, fluorinated polydiethyleneglycoldimethacrylate, and fluorinated polyexyanedioldiacrylate.

36. The method according to claim 27, wherein the mold is made of a material selected from: Si, Cr, Ni, Pt, and Ti.

37. The method according to claim 36, further comprising the step of applying a releasing agent on the patterned surface of the mold before said step of patterning the core layer.

38. The method according to claim 27, wherein the core layer is provided in direct contact with a support.

39. The method according to claim 38, wherein the support is made of a material selected from: polyetherimide, polyimide, polycarbonate, polyurethane, quartz, and glass.

40. The method according to claim 27, wherein the core layer is provided on a support provided with a lower cladding layer of a first elastomeric material in contact with the silicone elastomeric material of the core layer.

41. The method according to claim 40, wherein the lower cladding layer is made of a first silicone elastomer in contact with the core layer.

42. The method according to claim 41, wherein the first silicone elastomer is a curable silicone material having a lower refractive index than the refractive index of the core layer.

43. The method according to claim 41, wherein the first silicone elastomer is a polysiloxane having a lower refractive index than the refractive index of the core layer.

44. The method according to claim 41, wherein said first silicone elastomer is cured after being provided on said support.

45. The method according to claim 27, further comprising the step of providing an upper cladding layer of a second elastomeric material on the core layer after the step of removing the substantially rigid mold from the patterned core layer.

46. The method according to claim 45, wherein said upper cladding layer is provided on the core layer after curing the latter.

47. The method according to claim 45, wherein the second elastomeric material is a second silicone elastomer.

48. The method according to claim 47, wherein the second silicone elastomer is a curable silicone material having a lower refractive index than the refractive index of the core layer.

49. The method according to claim 47, wherein the second silicone elastomer is a polysiloxane having a lower refractive index than the refractive index of the core layer.

50. The method according to claim 47, wherein said second silicone elastomer is cured after being provided on said core layer.

51. The method according to claim 40, wherein said first silicone elastomer and said second silicone elastomer have substantially equal refractive indexes.

52. The method according to claim 47, wherein said first silicone elastomer and said second silicone elastomer have substantially equal refractive indexes.

53. The method according to claim 40, wherein said first silicone elastomer and said second silicone elastomer are equal.

54. The method according to claim 47, wherein said first silicone elastomer and said second silicone elastomer are equal.
